(19) United States
(12) Patent Application Publication
(10) Pub. No.: US 2023/0003188 A1
(43) Pub. Date: Jan. 5, 2023

(54) KITE-BASED ENERGY GENERATION CONTROL SYSTEMS AND RELATED METHODS

(71) Applicant: North Carolina State University, Raleigh, NC (US)

(72) Inventors: Chris Vermillion, Raleigh, NC (US); James Christopher Reed, Raleigh, NC (US); Joshua L. Daniels, Raleigh, NC (US); Mitchell Cobb, Raleigh, NC (US); Ayaz Siddiqui, Raleigh, NC (US)

(21) Appl. No.: 17/851,951

(22) Filed: Jun. 28, 2022

Related U.S. Application Data
(60) Provisional application No. 63/215,751, filed on Jun. 28, 2021.

(51) Int. Cl. F03D 5/06; B64C 31/06; F03D 13/20; F03D 9/32

(52) U.S. Cl. CPC F03D 5/06; B64C 31/06; F03D 13/20; F03D 9/32; F05B 2240/921

(57) ABSTRACT

Various examples are provided related to kite energy generation. In one example, a method for kite-based energy generation includes deploying a kite in a flow of fluid; controlling movement of the kite along a continuous pattern across the flow, where the kite applies tension greater than a threshold during at least a first portion of the pattern and applies tension less than the threshold during at least a second portion of the pattern; and generating power during the first portion of the continuous pattern. In another example, a system includes a kite including control surfaces that control movement of the kite along a continuous pattern across the flow of fluid; a winch connected to the kite by a tether, and a generator of the winch that can generate power during a portion of the pattern; and a spool controller that can control spooling of the tether during the pattern.

### CROSS REFERENCE TO RELATED APPLICATIONS

This application claims priority to, and the benefit of, co-pending U.S. provisional application entitled “Kite-Based Energy Generation Control Systems and Related Methods” having Ser. No. 63/215,751, filed Jun. 28, 2021, which is hereby incorporated by reference in its entirety.

### STATEMENT REGARDING FEDERALLY SPONSORED RESEARCH OR DEVELOPMENT

The present invention was made with United States Government support under Grant No. DE-EE0008635 awarded by the U.S. Department of Energy and under Grant No. 1727779 awarded by the National Science Foundation. The United States Government has certain rights in the invention.

### BACKGROUND

Wind, ocean currents, and tidal resources all represent promising and growing sources of renewable energy worldwide. On the other hand, the strongest sources of these renewable energy resources often exist in locations that are difficult to reach with conventional devices. For example, winds at altitudes of 500-1000 meters routinely possess power densities exceeding 500 W=m² throughout the world; however, these altitudes are unreachable with towered systems. Additionally, western boundary currents within the ocean contain a tremendous untapped resource, estimated at 25 GW in the Florida Straits and even more off of Cape Hatteras. However, this resource lies in waters that are hundreds of meters deep or more.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of operations and coordinate systems for an ocean kite, in accordance with various embodiments of the present disclosure.

FIG. 2 illustrates an example of a control formulation for spooling control and low level flight control, in accordance with various embodiments of the present disclosure.

FIG. 3 illustrates an example of a tether tension profile, in accordance with various embodiments of the present disclosure.

FIGS. 4 and 5 illustrate visualizations of the control law with an example tension profile at a single value of path variable where the optimal spooling action are a spool-out motion and a spool-in motion, in accordance with various embodiments of the present disclosure.

FIG. 6 illustrates an example of a four-stage hierarchical flight controller, in accordance with various embodiments of the present disclosure.

FIGS. 7 and 8 illustrate examples of spooling strategy, in accordance with various embodiments of the present disclosure.

FIG. 9 illustrates an example of tether length over a flow speed simulation, in accordance with various embodiments of the present disclosure.

FIG. 10 is a table illustrating simulation results of control strategies, in accordance with various embodiments of the present disclosure.

FIG. 11 illustrates an example of a control system block diagram, in accordance with various embodiments of the present disclosure.

FIG. 12 illustrates an example of an ocean velocity profile, in accordance with various embodiments of the present disclosure.

FIGS. 13A and 13B are tables illustrating examples of parameters used in the simulations and average power produced in the simulation sets, in accordance with various embodiments of the present disclosure.

FIGS. 14A-14E illustrate examples of simulation results, in accordance with various embodiments of the present disclosure.

FIG. 15 illustrates an example of a kite-based energy generation system, in accordance with various embodiments of the present disclosure.

FIG. 16 illustrates an example of a four stage hierarchical controller, in accordance with various embodiments of the present disclosure.

FIG. 17 an example of a winch controller state machine, in accordance with various embodiments of the present disclosure.

FIGS. 18A-180 illustrate an example of a two-dimensional planar slice (transect) of the Gulf Stream and sample data across the transect, in accordance with various embodiments of the present disclosure.

FIG. 19 is a table illustrating examples of parameters used in simulations, in accordance with various embodiments of the present disclosure.

FIGS. 20A-20D illustrate examples of simulation results, in accordance with various embodiments of the present disclosure.

### DETAILED DESCRIPTION

Disclosed herein are various examples related to kite energy generation. The concept of tethered energy systems has emerged out of the desire to harvest high-altitude winds and deep-water marine hydrokinetic (MHK) resources. In particular, by replacing conventional towers with tethers and a lifting body (a rigid wing or kite), it becomes possible to reach high-altitude winds and harvest MHK resources in deep waters. This disclosure describes a novel methodology to optimally control the winch spooling of a tethered cross-current energy harvesting apparatus.

This technology can optimize the power production through a three-part strategy. First, using Pontryagin's minimum principle, a closed form solution can be derived to maximize the amount of power generated by a kite flying cross-current to a fluid subject to tether length constraints. Second, to estimate the quantities in the derived solution, an iterative controller can be employed to drive the net amount of tether spooled to zero at steady state cross-current flight. This can eliminate the drifting element that can occur through intra-cycle spooling where net positive power is generated over one lap of the flight path by using the tension in the tether to drive a generator during the high tension portions of the path and reeling the tether in during low tension portions of the path. Third, over parts of the path that are observed to involve lower tensions in the tether, tensions can be lowered further through deflection of a control surface or control surfaces. This three-part strategy can greatly increase the net power generation of a tether energy harvesting apparatus flying in cross-current patterns. Control of winch spooling for tethered, cross-current flight can regulate tether length while simultaneously maximizing power generation.

Commercial systems generating power using tension generated in cross-current motion typically spool out tether while the kite repeatedly follows a path until the tether has reached an upper limit, at which point the tether is retracted while the kite glides back to the starting position. The problems with this strategy include the challenges associated with spooling long lengths of tether and the lack of transition states. By avoiding spooling hundreds of meters of tether repeatedly during power generation, the winches are less likely to “bunch up” the tether and create snags and knots. In addition, spooling in and out within each figure-8 cycle eliminates the challenging control problem of switching between fundamentally different flight modes (cross-current and stationary flight) present in other control implementations. By using the disclosed control strategies, the human element of choosing the tether release speed can be removed and replaced by the computed best possible (optimal) value.

One possible use includes tethered energy systems. The combination of optimal spool speed, tether length control, and intracycle spooling is purpose-built to improve and eliminate inefficiencies in tethered energy systems. These tethered energy systems include airborne and underwater kites, and aerostats that can be deployed to fly perpendicular to a moving fluid. The disclosed technology has applications in airborne wind energy systems and tethered undersea kites. These energy systems, along with the disclosed spool strategy, are not limited to being deployed from permanently stationary ground stations but can be deployed from floating buoys or parked battery-powered vehicles which need to charge. A separate lower-level controller can be utilized by the control strategy to ensure the kite follows a predefined path. Processing circuitry or a computer can provide real-time control for the proposed strategy and the low-level flight controller. Sensors include, e.g., a six degree-of-freedom IMU, barometers, line angle sensors, and a load cell. Reference will now be made in detail to the description of the embodiments as illustrated in the drawings, wherein like reference numbers indicate like parts throughout the several views.

The concept of tethered energy systems has emerged out of the desire to harvest high-altitude winds and deep-water marine hydrokinetic (MHK) resources. In particular, by replacing conventional towers with tethers and a lifting body (a rigid wing or kite), it becomes possible to reach high-altitude winds and harvest MHK resources in deep waters. In addition to providing access to the aforementioned high power-density resources, tethered systems that deploy high lift/drag lifting bodies, often referred to as kites (even though the lifting body is most often a rigid wing) can perform power-augmenting crosswind (in the air) and cross-current (in the ocean) motion. Here, the kite is flown in either figure-8 or elliptical patterns perpendicular to the prevailing flow, which has been shown to enable more than an order of magnitude more power generation than an equivalently-sized stationary system. This potential for substantial power augmentation has led dozens of companies and research organizations to develop tethered systems that execute power augmenting crosswind and cross-current motions.

Tethered systems can harvest energy in either of two ways:
Turbine-based generation, sometimes referred to as “fly-gen” operation, where turbines are fixed to the kite, and power is transmitted via a conductive cable to a base station, or
Tension-based generation, sometimes referred to as \ground-gen” operation, where the power is produced by a winch/generator at a base station by spooling the tether out under high tension and in under low tension.

The present disclosure addresses the second mode of operation. Generally speaking, the spool-out/spool-in profile utilized in this mode of operation can fall into one of two categories, or a combination thereof:
Multi-cycle spooling, where the kite is spooled out under high tension continuously for multiple cycles of the path to a maximum allowable tether length, then spooled in under low tension. The low tension can be achieved by either gliding radially towards the base-station, or maintaining its path following configuration, but still flying at a low angle of attack.
Intra-cycle spooling, where within a single lap, there exists a high-tension portion of that lap where the kite is spooled out at a high angle of attack and a low-tension portion where it is spooled in at a low angle of attack.

In the tethered wind energy community, multi-cycle spooling and intra-cycle spooling have been implemented. MHK kites have been simulated performing multi-cycle spooling. While a “pure” multi-cycle spooling approach that does not employ any form of intra-cycle spooling (i.e., an approach where tether is spooled out during the entirety of each figure-8 or ellipse, then spooled in under non-crosswind/non-cross-current flight) is theoretically the most efficient mechanism for power generation under a constant flow profile, several complications arise that often motivate or necessitate some level of intra-cycle spooling:
(1) Heavier-than-air tethered wind energy systems must fight gravity and often need to put energy back into the system in the corners of the figure-8 or elliptical flight paths.
(2) In significant shear environments, which are seen in both wind and MHK applications, it is desirable to maintain a relatively consistent altitude/depth, which needs a consistent tether length for a given elevation angle. Intra-cycle spooling can allow for a relatively consistent tether length and the targeting of these specific altitudes/depths.
(3) Transitioning into and out of crosswind/cross-current flight is non-trivial and will occur hundreds of times a day under the most efficient multi-cycle spooling strategy. An intra-cycle spooling strategy allows the kite to remain in crosswind/cross-current flight, using the corners of the flight path (which are naturally inclined toward delivering significantly lower tether tensions) to achieve low-tension spool-in.

For an intra-cycle spooling strategy, the spooling speed profile over the course of the figure-8 or elliptical path becomes an important decision variable for maximizing net power output. The optimal spool-out speed has been identified as one third of the flow speed, but this is based on a simplified 2D quasi-static analysis under a direct-downwind configuration. Although significant recent research has focused on optimal tether length and elevation angle regions, optimal holding patterns, and optimal periodic flight paths, there is no result that computes the optimal intra-cycle spooling profile on a 3D crosswind/cross-current flight path.

In this disclosure, continuous-time optimal control tools, including Pontryagin's Maximum Principle, are utilized to derive the optimal spooling profie for a tethered energy system undergoing intra-cycle spooling. For the present work, a constraint that zero net spooling occurs over each lap is imposed; however, the formulation can be extended to multiple laps. Application of Pontryagin's Maximum Principle to the intra-cycle spooling problem yields optimal spooling speed profiles during the spool-in and spool-out modes of operation. Additionally, the solution of the optimal control problem provides a mechanism for selecting which parts of the path should be used for spool-in vs. spool-out operation. However, this selection mechanism is based on a co-state value that is identified to be equal to a constant but is otherwise undetermined by the optimal control conditions. In order to identify the correct value of this constant, which is needed to ensure that the zero net spooling constraint is satisfied, the optimal spooling controller can be augmented with an iteration-domain feedback controller that adjusts the estimated co-state value based on net spooling over each lap. Using a medium-fidelity model of an MHK kite system, the efficacy of the optimal spooling controller is demonstrated for multiple flow speeds, demonstrating between 14 and 45% improvement in energy production over a baseline spooling strategy.

Plant Model

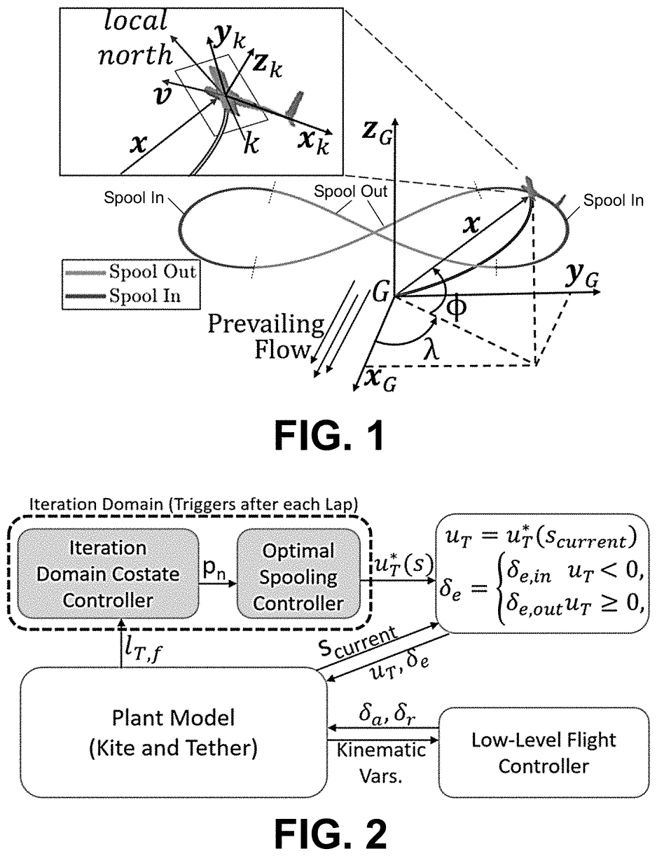

In this disclosure, an ocean kite that executes figure-8 cross-current paths perpendicular to the flow direction is considered. The overall concept of operations and coordinate systems for the kite are shown in FIG. 1. The model used for simulations and as a basis for the simplified formulation used to set up the continuous-time optimal spooling problem is adopted. FIG. 1 illustrates the ground station and kite coordinate systems, along with an example of an intra-cycle spooling strategy and spherical coordinate angles A and ϕ. A full summary of this model is included for completeness.

Cross-Current Kite Dynamics. The kite is modeled as a combination of two elements:
(1) A rigid lifting body whose forces and moments are calculated from lift, drag, buoyancy, and gravity;
(2) A tether model whose links are comprised of non-compressive damper elements, with hydrodynamic, gravitational, and buoyant forces applied at the nodes (including the end nodes).

6-DoF Lifting Body (Kite) Model. Two coordinate systems, a body-fixed and ground-fixed frame, can be used to characterize the kite's dynamics. The body-fixed coordinate frame, whose origin lies at the kite's center of mass (point k in FIG. 1), is characterized by orthonormal unit vectors xₖ, yₖ, and zₖ. The ground-fixed frame, whose origin lies at point G of FIG. 1, is characterized by orthonormal unit vectors x_{G}, y_{G}, and z_{G}. The state variables describing the position and orientation (and rates of change of the position and orientation) of the kite evolve according to standard nonlinear equations of motion:

\dot{μ}=ƒ(μ,ω)

J\dot{ω}=M_{Net}−ω×Jω

\dot{x}=R(μ)v

M\dot{v}=(F_{Net}(t)−ω×v) (1)

Here, the orientation of the kite is described by the vector of conventional Tait-Bryan Euler angles, μ [symbol] [ϕθψ]^{T}, where ϕ is roll, θ is pitch, and ψ is yaw. The matrix J∈ [symbol] ^{3×3} is the apparent inertia matrix, and M_{Net} is the sum of all applied moments, expressed in the body frame. Here, the position vector, x∈ [symbol] ³, is the vector from the point G to the point k, expressed in the ground frame. The vector v is the associated velocity, expressed in the body frame. The matrix R∈ [symbol] ^{3×3} is the rotation matrix from the body to the ground frame. The variable M∈ [symbol] ^{3×3} is the diagonal apparent mass matrix, F_{Net} is the sum of all forces applied to the kite expressed in the body frame, and ω [symbol] [ωₓ ω_{y} ωz]^{T} is the kite's body-frame angular velocity. Finally, the function ƒ (μ, ω) is given by:

$$f ( μ , ω ) = [ \begin{matrix}{ω}_{x} + {ω}_{y} sin ( ϕ ) tan ( θ ) + {ω}_{z} cos ( ϕ ) tan ( θ ) \\ {ω}_{x} cos ( ϕ ) - {ω}_{z} sin ( ϕ ) \\ ( {ω}_{y} sin ( ϕ ) + {ω}_{z} cos ( ϕ ) ) sec ( θ )\end{matrix} ] . \qquad ( 2 )$$

The kite is subject to forces and moments resulting from five fluid dynamic surfaces (a fuselage, port wing, starboard wing, horizontal stabilizer and vertical stabilizer), buoyancy, gravity, and the tether. These forces and moments are calculated as:

$${F}_{Net} = {F}_{Thr} + ( V ρ - m ) {gz}_{G} + \frac{1}{2} ρ {A}_{r} {\sum }_{i = 1}^{5} {‖ {v}_{{a}_{i}} ‖}^{2} ( {C}_{L , i} {u}_{L , i} + {C}_{D , i} {u}_{D , i} ) \qquad ( 3 )$$

$${M}_{Net} = \frac{1}{2} ρ {A}_{r} {\sum }_{i = 1}^{5} {‖ {v}_{{a}_{i}} ‖}^{2} {r}_{{a}_{i}} \times ( {C}_{L , i} {u}_{L , i} + {C}_{D , i} {u}_{D , i} ) , \qquad ( 4 )$$

where in equation (3), the first term is the force exerted at the center of mass by the tether on the lifting body, the second term describes the net buoyant force, and the last term describes the fluid dynamic forces. Here, V is the volume of the kite, ρ is the fluid density, m is the mass of the system, and g is the acceleration due to gravity.

The index, i, refers to each of the five independent fluid dynamic surfaces. Therefore, the resulting force depends on the apparent flow at the aerodynamic center of each surface, which can be calculated as:

vₐ_{ᵢ}=v_{ƒ}−(v+ω×_{rα}_{ᵢ}), (5)

where v_{ƒ} is the constant flow velocity for the simulation and rₐ_{ᵢ} is the vector from the center of mass of the kite to the fluid dynamic center of the i^{th} surface. The fluid dynamic coefficients of equations (3) and (4) are obtained by modeling each fluid dynamic surface independently in the Athena Vortex Lattice (AVL) software and parameterized as functions of the associated control surface deflections, δᵢ, as:

C_{(L,D),i}(vₐ_{ᵢ})=_{C(L}_{₀}_{,D}_{₀}_{),i}(vₐ_{ᵢ})+C_{(L}_{₁}_{,D}_{₁}_{),i}δᵢ, (6)

where the control sensitivity coefficients, C_{L}_{₁}_{,i}, C_{L}_{₂}_{,i}, C_{D}_{₁}_{,i}, and C_{D}_{₂}_{,i} are obtained from AVL. The spanwise lift coefficient distributions, C_{i,i}(y), obtained from the software can be heuristically corrected to account for nonlinear stall behavior that is not present in AVL. This correction can be given by:

$${C}_{{L}_{0} , i} = {\sum }_{j = 1}^{{N}_{c}} \{ \begin{matrix}{C}_{l , i} ( {y}_{j , i} ) \\ 2 {C}_{{l}_{max} , i} ( {y}_{j , i} ) \\ - {C}_{l , i} ( {y}_{j , i} )\end{matrix} \begin{matrix}{C}_{l , i} ( {y}_{j , i} ) < {C}_{{l}_{max}} ( {y}_{j , i} ) \\ {C}_{l , i} ( {y}_{j , i} ) \geq {C}_{{l}_{max}} ( {y}_{j , i} )\end{matrix} , \qquad ( 7 )$$

where N_{c} is the number of control points used in the AVL analysis, y_{j,i} is the span-wise location of the j^{th} control point of surface i, and Cₗ_{ₘₐₓ}(y_{j,i}) is the maximum airfoil lift coefficient at the j^{th} control point of surface i.

Finally, the unit vectors describing the direction of the lift and drag forces (u_{D,i} and u_{L,i}, respectively) are calculated from the apparent wind direction vector at the i^{th} aerodynamic center.

Tether Model. The tether can be modeled as a non-compressive spring damper subjected to buoyancy, gravity, and fluid drag. The expression for the net force at the end of the tether attached to the kite (the first term in equation (3)) can be given by:

$${F}_{Thr} = \frac{1}{2} ( ( ρ - {ρ}_{T} ) π {r}_{T}^{2} {l}_{T} {gz}_{G} + \frac{1}{2} ρ {‖ {v}_{a , T} ‖}^{2} {A}_{p , T} {C}_{D , T} \frac{{v}_{a , T}}{‖ {v}_{a , T} ‖} + {F}_{Ten} ) , \qquad ( 8 )$$

where ρ_{T} is the density of the tether, r_{T} is the radius of the tether, l_{T} is the un-spooled tether length, A_{p,T} is the area of the tether projected in the direction of the apparent flow, C_{D,T} is the drag coefficient of the tether, and v_{a,T} is the apparent flow speed at the midpoint of the tether, which is given by v_{a,T}=V_{ƒ} −v/2. Lastly, F_{Ten} is the nonlinear spring damper force which is calculated according to:

$${F}_{Ten} = \{ \begin{matrix}0 & ‖ x ‖ < {l}_{T} , \\ \frac{1}{2} ( - {E}_{y} \frac{π {r}_{T}^{2}}{{l}_{T}} ( ‖ x ‖ - {l}_{T} ) & otherwise \\ - 2 ζ \sqrt{{E}_{y} \frac{π {r}_{T}^{2}}{{l}_{T}}} m \frac{d}{dt} ‖ x ‖ ) \frac{x}{‖ x ‖} & \end{matrix} , \qquad ( 9 )$$

where E_{y} is the Young's modulus of the tether and ζ is the non-dimensional damping ratio.

Un-spooled tether length, l_{T}, can be calculated through the simple integration of the tether spooling speed, ũ_{T}:

l_{T}(t)=∫₀^{t}ũ_{T}(τ)dτ, (10)

The winch dynamics, which relate the commanded spooling speed, u_{T}, to the actual spooling speed, ũ_{T}, are based on simple first-order dynamics with upper and lower saturation limits.

Defining ũ_{T}(t) as the spool speed of the tether, the instantaneous mechanical power produced by the system, P_{gen}(t), is modeled as

P_{gen}(t)×∥Fₜₕᵣ∥ũ_{T}(t).

Control Formulation

The goals of the optimal intra-cycle spooling controller include two:
(1) Maximize average net power production over the course of a lap.
(2) Begin and end each lap at a desired tether length.

The resulting spooling profile comprises spooling speed as a function of path position. A lower-level path-following controller executes this spooling profile while also articulating control surfaces to negotiate the prescribed cross-current flight path. FIG. 2 illustrates an example of a control formulation including high level optimal spooling control and low level flight control, which shows how the various elements of the control system interact.

Optimal Control Problem Formulation. In this work, mechanical energy output is treated as the control goal (with the inclusion of motor and generator efficiency maps as a topic for follow-on simulation studies). Consequently, the control goal over one lap, for a given initial time, t₀, and final time, t_{ƒ}, is to maximize net mechanical energy output (the integration of tension with spooling speed), subject to the spooling dynamics of equation (10). This can be written as follows:

Maximize J(ũ_{T})=∫ₜ_{₀}^{t}^{_{ƒ}}T(μ(t),ω(t),x(t),v(t))ũ_{T}(t)dt, (11)

subject to i_{T}(t)=ũ_{T}(t), Eqn. set (1),

where T(μ(t), ω(t), x(t), v(t)) is the tension in the tether at the ground station. The tether tension over the course of a lap depends nonlinearly on the kite's velocity and orientation, along with the characteristics of the tether. However, for a particular flow speed, flight path, and lower level flight controller (which is assumed to be fixed for the purpose of the optimal spooling controller design), it is possible to reasonably approximate tension as a function of spooling speed, ũ_{T}, and position along the path, s, which have the largest impacts. To simplify matters further, because the winch time constants (on the order of one tenth of a second) are far faster than the kite's time constants (which in an ocean environment are tens of seconds), the actual spooling speed, ũ_{T}, is approximated to be equal to the commanded winch speed, u_{T}. These assumptions lead to the following simplified optimal control problem:

J=∫ₜ_{₀}^{t}^{_{ƒ}}T(s(t),u_{T}(t))u_{T}(t)dt, (12)

subject to i_{T}(t)=u_{T}(t),

where s(t) is the path variable, which goes from 0 to 1 as the kite traverses the path, resetting upon each completed lap, u_{T}(t) is the commanded spooling speed, T(s(t),u_{T}(t)) is the tension as a function of path variable and spooling speed, and i_{T} is the time derivative of the tether length, which is the only state variable (not present in the objective function).

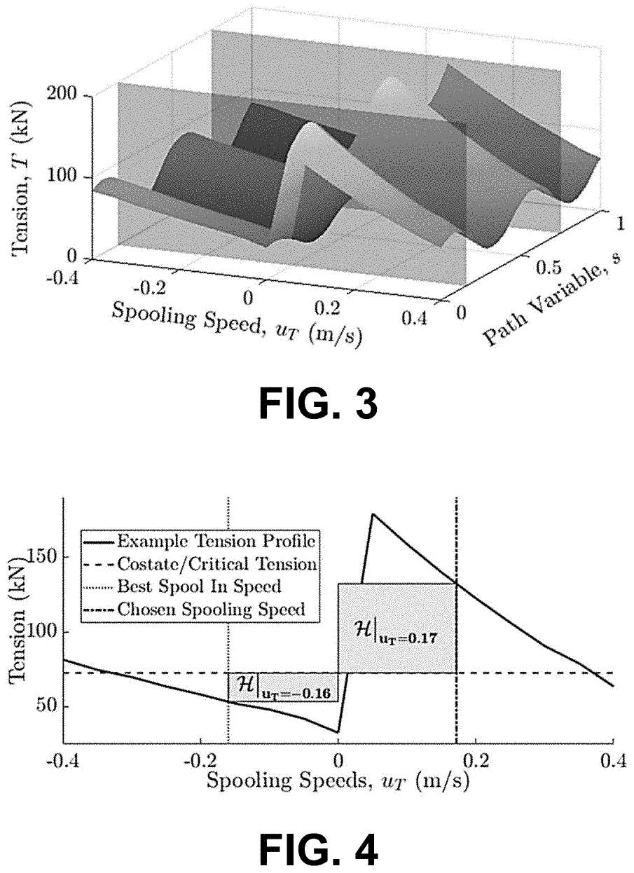

Tension Function Characterization. Based on the simplified optimal control formulation of equation (12), it is important to characterize T(s,u_{T}). FIG. 3 represents one such tension profile (the significance of the vertical planes is described in the following sub-section). FIG. 3. Illustrates an example of tether tension as a function of path variable and spooling speed for a figure-8 path, a flow speed of 1 m/s, and a l_{T,des} of 125 m. The process by which this profile is generated is detailed in this sub-section. Along the path variable, s, axis, the surface follows a cyclic pattern. This is because the velocity of the kite increases along the straightaways in the figure-8, generating high lift and high tension, while the curves have the opposite effect. Along the spooling speed, u_{T}, direction, the surface decreases as spooling speed increases. This is due to a higher spooling speed inducing motion in the direction of flow, reducing apparent velocity, lift, and tension. The discontinuity seen at a spooling speed of zero is due to the intentional differences in angle of attack (dictated by elevator deflection) in spool-out vs. spool-in operation. When spooling speed is positive or zero, the elevator is set to maximize lift and tension, when spooling in, the elevator is deflected to reduce the angle of attack and lower tension.

Representative T(s, u_{T}) functions as shown in FIG. 3 were computed at a variety of flow speeds by simulating the full system dynamics with varied spooling speed magnitude. To minimize the effect that variations in tether length have on the tension, the tether was spooled no more than 15 meters away from l_{T,des}. The simulations were run for 3000 seconds, and values of tension, spooling speed, and path variable were recorded. Values within 5 seconds of a transition between spooling out and spooling in were discarded to allow for transients to settle. The average tension for values at a single spooling speed and path variable were saved into the T(s, u_{T}) surface.

PMP-Based Optimal Controller. Optimal Spooling Control Law. In order to find the necessary conditions for a solution to the optimal control problem, the Hamiltonian, [symbol] (u_{T}(t), s(t), pₙ), can be generated from the objective function and constraint. The Hamiltonian for this problem can be given by:

[symbol]

(u_{T}(t),s(t),pₙ)=[T(s(t),u_{T}(t))−pₙ]u_{T}(t), (13)

where u_{T}(t) is the spooling speed, and pₙ is the co-state. It will be shown that the co-state for this particular problem can be interpreted as a critical tension, which can be used to determine when to switch between spool-out and spool-in motions.

The conditions for optimality can then be given by:
(1) i_{T}=u_{T}(t), which simply represents the state dynamics of equation (12),
(2) \dot{p}=0, indicating the co-state will be constant, and
(3) [symbol] (u_{T}*(t),s(t),p*)≥ [symbol] (u_{T}(t),s(t),p*) for all admissible u_{T}(t), where u_{T}*(t) is the optimal control trajectory and p* is the optimal co-state value, which is a direct application of Pontryagin's Maximum Principle (PMP) for this problem.

Applying PMP to the Hamiltonian in equation (13) results in the immediate conclusions that (i) the co-state, pₙ, has units of tension, and (ii) the optimal decision on whether to spool in (u_{T}(t)<0) or spool out (u_{T}(t)>0) is based on comparing T(s(t),u_{T}(t)) with pₙ. Thus, the co-state is referred to as a critical tension.

Ultimately, the optimal spooling speed at any point within the cross-current path, u_{T}*(t)) given by:

$${u}_{T}^{*} ( s ( t ) ) = {arg max}_{{u}_{T}} ℋ ( {u}_{T} ( t ) , s ( t ) , {p}_{n} ) , \qquad ( 14 )$$

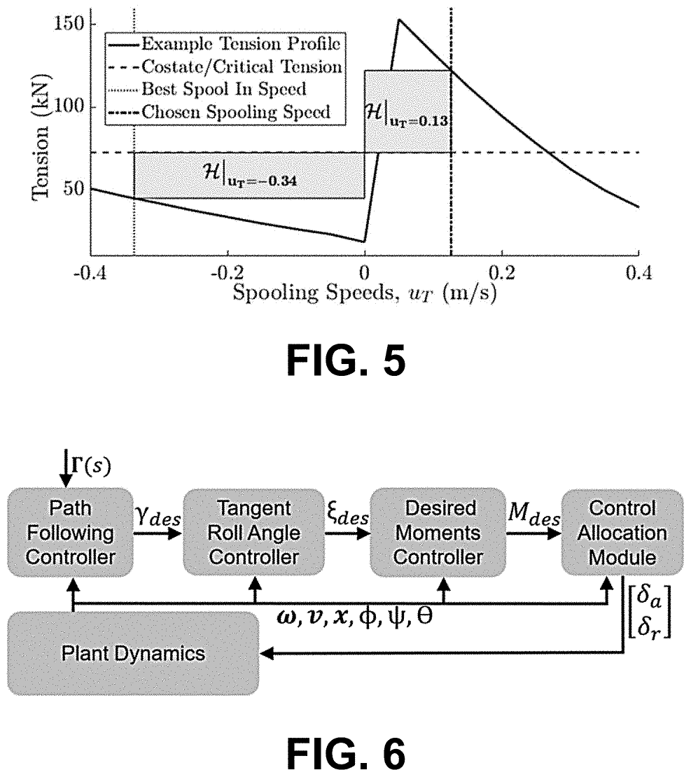

is visualized at two instances in the flight path, denoted by the vertical planes in FIG. 3, based on the illustrations in FIGS. 4 and 5. FIGS. 4 and 5 are visualizations of the control law with an example tension profile at a single value of path variable where the optimal spooling action is a spool-out motion at approximately 0.18 m/s and where the optimal spooling action is a spool-in motion at approximately 0.35 m/s, respectively. The process for computing u_{T}* involves finding the spooling speed (in or out) that maximizes the area of the indicated rectangle in FIGS. 4 and 5, which is equal to [symbol] (u_{T}(t),s(t),pₙ). FIGS. 4 and 5 show the rectangle generated from both the best spool-in speed and the best spool-out speed for reference, but only the spooling speed that produces the largest rectangle (and largest value for [symbol] (u_{T}(t),s(t),pₙ)) is chosen as the optimal for that value of s.

Iteration-Domain Co-State Adjustment. In order to implement the control law given in equation (14), the optimal value of the co-state needs to be determined. Because of the second condition for optimality, \dot{p}=0, it is known that the co-state is constant over a given lap. However, the optimality conditions do not provide a mechanism for computing the actual value of p*. In order to find the value of the co-state which results in net-zero spooling, an iteration-domain (where one iteration corresponds to a lap) proportional plus integral (PI) update law for the co-state can be implemented, as follows:

$${p}_{n + 1} = {k}_{p} ( {l}_{T , n} - {l}_{T , des} ) + {k}_{i} {\sum }_{j = 1}^{n} ( {l}_{T , j} - {l}_{T , des} ) + {p}_{0} . \qquad ( 15 )$$

In this equation, kₚ and kᵢ are the proportional and integral gains respectively, p₀ is an initial guess for the value of the co-state, l_{T,n} and l_{T,j} are the tether lengths at the end of iterations (laps) n and j respectively, and l_{T,des} is the desired tether length.

Elevator Switching Control Law. Because it is desired to maximize fluid-dynamic forces during spool-out and minimize them during spool-in, the elevator can be used to trim the kite to a constant high angle of attack when spooling out and a constant, low angle of attack when spooling in. The elevator deflection, δₑ, can be calculated using the equation:

$${δ}_{e} ( {u}_{T} ) = \{ \begin{matrix}{δ}_{e , i n} & {u}_{T} < 0 , \\ {δ}_{e , out} & {u}_{T} \geq 0\end{matrix} , \qquad ( 16 )$$

where δ_{e,in} was selected to minimize tension while spooling in, and δ_{e,out} was selected to maximize tension while spooling out.

Low Level Cross-Current Kite Flight Controller. The flight control strategy is ultimately responsible for ensuring that the kite robustly tracks a prescribed figure-8 cross-current flight path. The figure-8 tracking control strategy contains four levels, as shown in the four-stage hierarchical flight controller of FIG. 6, each of which accept feedback from the plant in calculating their outputs. This modular, hierarchical control structure can be is partitioned into:
(1) A path following controller that accepts the path geometry and outputs a desired velocity angle.
(2) A tangent roll angle controller, which accepts a desired velocity angle and outputs a desired tangent roll angle, which is the angle between yₖ and the plane tangent to the surface of the sphere of radius 114 at the kite's position (shown in FIG. 1)—this angle dictates the component of hydrodynamic lift that contributes to turning in order to follow the path.
(3) A desired moments controller, which accepts the tangent roll setpoint and side slip angle setpoint, and outputs a desired moment vector.
(4) A control allocation module, which accepts the desired moment vector and computes the required aileron and rudder deflections (where the elevator deflection is prescribed as part of the spooling controller).

Path Following Controller. The path following controller takes in a path defined by:

$$Γ ( s ) = [ \begin{matrix}cos ( {λ}_{Γ} ( s ) ) cos ( {ϕ}_{Γ} ( s ) ) \\ sin ( {λ}_{Γ} ( s ) ) cos ( {ϕ}_{Γ} ( s ) ) \\ sin ( {λ}_{Γ} ( s ) )\end{matrix} ] , \qquad ( 17 )$$

where Γ(s) represents the path on a sphere in Cartesian coordinates, and λ_{Γ}(s) and ϕ_{Γ}(s) are the longitudinal and latitudinal spherical coordinates that describe the kite's position along the path. The path geometry used for the results of this disclosure was the Lemniscate of Booth using the parameters a_{booth}=0.5, b_{booth}=1, and a mean latitude of 20.63°.

Given this path, the controller calculates a three-dimensional vector representing the desired velocity of the system. This desired velocity vector can be taken to be a weighted average between the perpendicular vector, pi, and the parallel vector, p_{∥}*. The perpendicular vector can be given by:

$${p}_{⊥}^{*} = \frac{{\hat{p}}_{⊥}}{‖ {\hat{p}}_{⊥} ‖} where {\hat{p}}_{⊥} = [ \begin{matrix}( Γ ( {s}^{*} ) - x ) \cdot {u}_{ϕ G} ( x ) \\ ( Γ ( {s}^{*} ) - x ) \cdot {u}_{{λ}_{G}} ( x ) \\ 0\end{matrix} ] . \qquad ( 18 )$$

Here, u_{ϕ}_{_{G}}(x) and u_{λ}_{_{G}}(x) are the unit vectors in the elevation and azimuth directions, respectively, and are often referred to as “local north” and “local east.”

The parallel vector, p_{∥}*, is a unit vector that lies parallel to the path at the path variable corresponding to the closest point on the path, s* and can be calculated by:

$${p}_{∥}^{*} = \frac{{\hat{p}}_{∥}}{‖ {\hat{p}}_{∥} ‖} where {\hat{p}}_{∥} = \frac{d Γ}{ds} {\vert}_{s = {s}^{*}} \qquad ( 19 )$$

In equations (18) and (19), the closest point on the path is described by the path variable s*, which is the solution to the minimization problem:

$${s}^{*} = {arg min}_{s} α ( s ) , where tan ( α ( s ) ) = \frac{‖ x \times Γ ( s ) ‖}{x \cdot Γ ( s )} . \qquad ( 20 )$$

Here, α(s) is the angle between the position vector, x, and the path, Γ(s).

The desired velocity unit vector, v_{des}, can then be calculated as the linearly weighted sum of the perpendicular and parallel vectors, according to:

$$\overline{α} ( {s}^{*} ) = min \{ α ( {s}^{*} ) , {α}_{0} \} \\ {v}_{des} = ( 1 - \frac{\overline{α} ( {s}^{*} )}{{α}_{0}} ) {p}_{∥}^{*} + \frac{\overline{α} ( {s}^{*} )}{{α}_{0}} {p}_{⊥}^{*} . \qquad ( 21 )$$

Here, α₀ serves as an upper limit on the angle used in the weighting.

The velocity angle, γ, which describes the orientation of a given velocity vector on the sphere of radius ∥x∥ at the current position x, can be given by:

$$γ ( v ) = a tan ( \frac{v \cdot {u}_{ϕ G} ( x )}{v \cdot {u}_{{λ}_{G}} ( x )} ) . \qquad ( 22 )$$

The desired velocity angle, γ_{des}, is then given by γ(v_{des}).

Tangent Roll Angle Controller. The next level of the flight controller maps the desired velocity angle, γ(v_{des}), to a desired tangent roll angle, ξ_{des}, where the tangent roll angle can be given mathematically by:

$$tan ( ξ ( {y}_{k} ( t ) ) ) = \frac{{y}_{k} \cdot ( {u}_{{λ}_{G}} \times {u}_{{ϕ}_{G}} )}{\sqrt{{( {y}_{k} \cdot {u}_{{ϕ}_{G}} )}^{2} + {( {y}_{k} \cdot {u}_{{λ}_{G}} )}^{2}}} . \qquad ( 23 )$$

The desired tangent roll angle can be calculated using saturated proportional control, specifically:

ξ_{des}=min{max{k_{γ}(γ(v)−γ(v_{des})),ξₘᵢₙ},ξₘₐₓ}, (24)

where k_{γ} is a proportional gain.

Desired Moment Vector Selection. In selecting the desired moments, the rolling moment can be utilized to control tangent roll angle, ξ, to its target value of ξ_{des}, and a yawing moment to drive aerodynamic side slip angle, β, to a value of 0. Recall that the optimal tether spooling controller articulates the elevator to passively trim the system to a high angle of attack during spool-out and a low angle of attack during spool-in, according to equation (16). Therefore, it is desirable that the combined actions of the ailerons and rudder contribute negligible or zero additional pitching moment. Ultimately, the desired moment vector is given by:

$${M}_{des} = [ \begin{matrix}{k}_{{p}_{L}} {e}_{ξ} ( t ) + {k}_{{i}_{L}} {\int }_{0}^{t} {e}_{ξ} ( t ) d τ + {k}_{{d}_{L}} {\dot{e}}_{ξ} ( t ) \\ 0 \\ {k}_{{p}_{N}} β + {k}_{{i}_{N}} {\int }_{0}^{t} β d τ + {k}_{{d}_{N}} \dot{β}\end{matrix} ]$$

where e_{ξ} is the tangent roll angle tracking error, given by e_{ξ}(t)=ξ(yₖ(t))−ξ_{des}(t), and β is the fluid dynamic side slip angle.

Control Allocation Module. In order to map the desired moment vector to the necessary control surface deflections, an approximation of the deflection-moment mapping used in the plant model can be inverted. This approximation can be calculated by neglecting the effect of angular velocity on the apparent flow at each fluid dynamic surface and performing a linearization. Under this approximation, equations (4) and (6) can be rearranged to the form:

$${M}_{net} = {M}_{o} + A [ \begin{matrix}{δ}_{a} \\ {δ}_{e} \\ {δ}_{r}\end{matrix} ] , \qquad ( 25 )$$

where δₐ is the deflection angle of the ailerons, δₑ is the deflection angle of the elevators, and δᵣ is the deflection angle of the rudder. In this expression, the variable Mₒ is given by:

$${M}_{o} = \frac{1}{2} ρ {A}_{r} {‖ {υ}_{a} ‖}^{2} {\sum }_{i = 1}^{4} {r}_{{a}_{i}} \times ( {C}_{{L}_{o} , i} {u}_{L , i} + {C}_{{D}_{o} , i} {u}_{D , i} ) \qquad ( 26 )$$

and the matrix A is formed by re-arranging the cross products and deflection angles in equations (4) and (6) into a matrix form where the results of the cross products form the columns of the matrix:

$$\begin{matrix}A = \frac{1}{2} ρ {A}_{r} {‖ {υ}_{a} ‖}^{2} [ {a}_{1} - {a}_{2} , {a}_{2} , {a}_{3} ] & where \\ {a}_{i} = {r}_{{a}_{i}} \times ( {C}_{{L}_{1} , i} {u}_{L , i} + {C}_{{D}_{1} , i} {u}_{D , i} ) & \end{matrix} \qquad ( 27 )$$

Along with the elevator deflection, δₑ, from equation (16), the resulting control surface deflections, oₐ and 8ᵣ, are computed by solving equation (25) for Mₙₑₜ=M_{des}.

Results

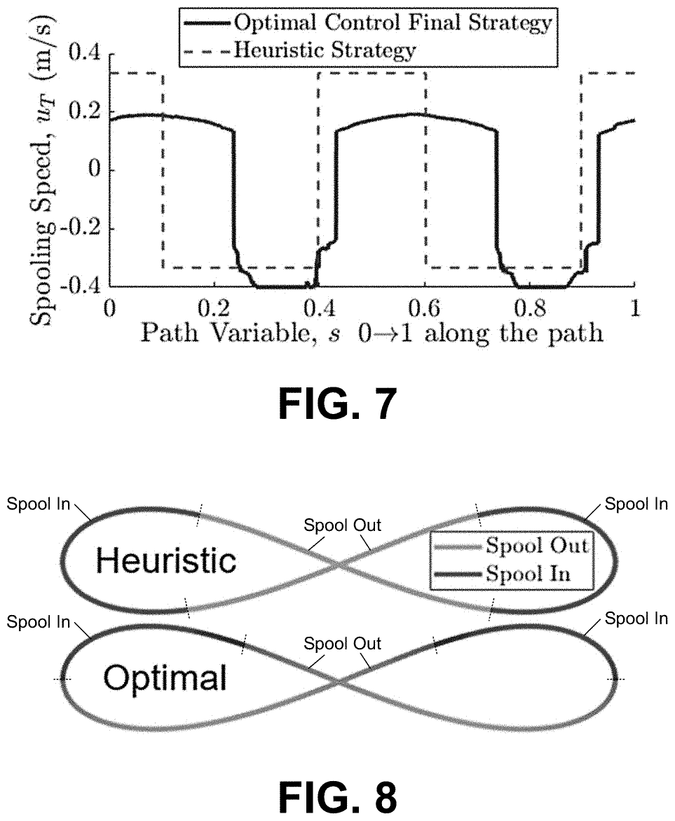

Simulations were performed over a range of flow speeds from 0.5 to 2 m/s and desired tether lengths of 125 and 200 m. All simulations had a duration of 2000 seconds and used the same path geometry, flight controller parameters, kite dimensions, and tether properties. The kite model used had a span of 10 m, reference area of 10 m², and a mass of 945 kg. Examples of the spooling strategies obtained at a target tether length 125 m and flow speed 1 m/s are shown in FIGS. 7 and 8. FIG. 7 illustrates optimal and heuristically chosen spooling strategy examples over a single figure-8 lap at a flow speed of 1 m/s and a target tether length of 125 m and FIG. 8 illustrates optimal and heuristically chosen spooling strategies displayed on the figure-8 path, where the brighter sections of the gradient on the optimal figure-8 correspond to the fastest spooling speed. The optimal control strategy shown in FIG. 8 was taken from the last completed figure-8 of the simulation in order to let the co-state value settle.

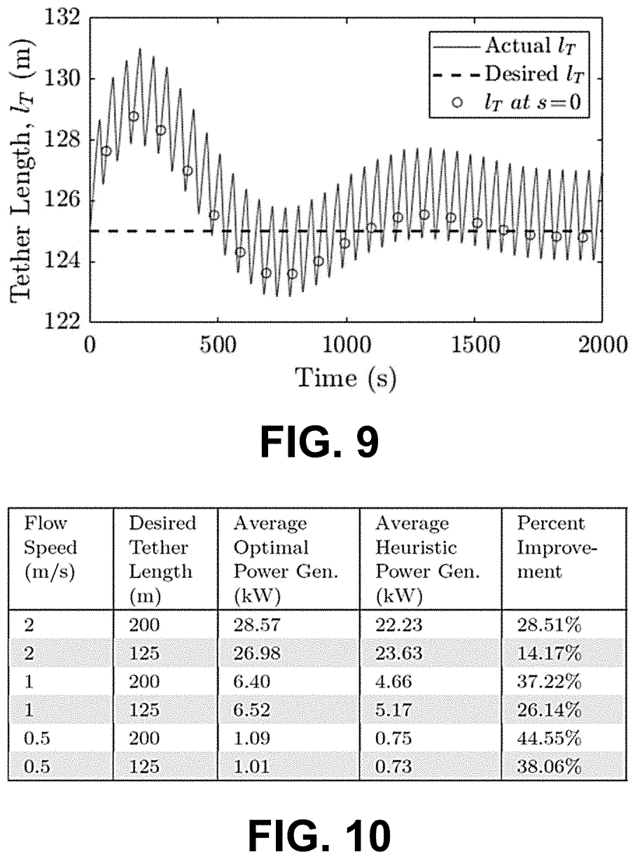

Another significant result is the ability of the iteration domain controller to drive the tether length to the desired value by adjusting the estimated value of the co-state. In FIG. 9, a continuous plot of the tether length can be seen with the values at the start of each path highlighted. FIG. 9 show tether length over a 1 m/s flow speed simulation, demonstrating the starting/ending positions being driven to the target value. As the simulation progresses, the values of the starting locations approach the desired length.

In order to understand the power numbers, the optimally chosen spooling speeds were compared against a heuristic strategy where spooling speeds were chosen at ⅓ of the flow speed. In the heuristic strategy, the kite was spooled in on the far edges of the path, for a manually chosen duration, to achieve zero net spooling. The average power was calculated after each simulation according to the equation:

$${P}_{avg} = \frac{{\int }_{{t}_{end} / 2}^{{t}_{end}} T ( t ) {\tilde{u}}_{T} ( t ) dt}{{t}_{end} - \frac{{t}_{end}}{2}} . \qquad ( 28 )$$

The average power calculation was limited to the second half of each simulation to allow the value of the estimated co-state to settle. The results of the optimal control strategy and the heuristic strategy are illustrated in the table of FIG. 10, which shows the average power generation at various flow speeds and tether lengths. Here, only the spooling profile, not the path geometry (which can significantly influence average power generation), has been optimized. However, the same path geometry was used in all 12 simulations.

An optimal control problem was formulated that captured the nature of the optimal power take-off problem for an energy-harvesting kite employing cyclic spooling. The optimal control problem was then solved using continuous time optimal control techniques, resulting in an optimal spooling profile. The results demonstrate that, for a complex, nonlinear plant model, the controller is capable of augmenting power production by 14%-45% relative to a heuristic baseline strategy.

Realistic Ocean Current Modeling and Implementation

The flow field, which is characterized as a function of depth (zₒ), cross-current location (yₒ), and time (t), is computed as the superposition of a low-frequency flow profile and high-frequency turbulence model, as:

\tilde{V}_{comb}(yₒ,zₒ,t)=\tilde{V}_{turb}(yₒ,zₒt)+\tilde{V}(zₒ,t), (29)

where \tilde{V}(yₒ,zₒ,t), \tilde{V}_{turb} (yₒ,z₀,t), and \tilde{V}comb (yₒ, zₒ, t) represent the low-frequency flow field, high-frequency turbulent field, and combined flow model, respectively. Because the total cross-current motion of the kite spans a tiny fraction of the total current resource (e.g., the Gulf Stream), spatial variations in yₒ are neglected in the low-frequency model.

Low-Frequency Ocean Modeling. When available, observed ADCP data, collected by the Renewable Ocean Energy Program of the Coastal Studies Institute, was used to characterize low-frequency flow variations. This data profiles a location about 20 miles east of Cape Hatteras, N.C. on the shelf slope and is available at 10-minute time intervals and 4-meter vertical resolution. Because the ADCP data is specific to a particular location and is not usable in the top 40 meters of the water column due to surface reflections, MSR data was used as an alternative when simulating kite deployment of a sea surface platform (e.g., a fixed buoy). The MSR model was generated by North Carolina State University's Ocean Observing and Modeling Group, and provides current profiles at 42 different locations in the Gulf Stream at 25-meter vertical resolution. Each data set provides flow velocity vectors, \tilde{V}(zₒ, t), along the water column (i.e., the zₒ direction).

Modeled High-Frequency Turbulent Variability. The turbulent high-frequency components of the ocean currents can be calculated based on a discretization of the flow velocity's power spectral density (PSD) equation. Specifically, the model leverages fundamental techniques to generate a spatiotemporally varying turbulence profile that can be applied to the hydrodynamic center of each component in the dynamic model. Based on inputs of turbulence intensity, time-averaged flow velocity profile, a specified frequency range, standard deviations and spatial correlation coefficients for the flow velocities, the model outputs a spatial grid of time-varying velocity vectors on the inlet plane (which is n_{y} by n_{z}, having indices i and j ranging from 1 to n_{y} and 1 to n_{z}). The continuous PSD of flow velocity, G(ƒ), where ƒ represents frequency, is given as:

$$G ( f ) ∝ {f}^{- \frac{5}{3}} , \qquad ( 30 )$$

which implies G^{m}, the one-sided PSD, is equal to:

$${G}^{m} ( f ) = {A}_{m} {f}^{- \frac{5}{3}} . \qquad ( 31 )$$

Here, Aₘ is a constant defined by the equation:

$${A}_{m} = \frac{2 {\overline{U}}^{2} {T}_{m}^{2}}{3 [ \frac{1}{{f}_{min}^{\frac{2}{3}}} - \frac{1}{{f}_{max}^{\frac{2}{3}}} ]} , \qquad ( 32 )$$

where m is an index to the u, v, or w velocity components, ƒₘᵢₙ and ƒₘₐₓ define the frequency range of the turbulence, Ū is the magnitude of the time-averaged flow velocities, ū, v̅, and w̅, defined as:

Ū=ū²+\sqrt{v̅²+w̅²}, (33)

and where turbulence intensity, denoted by Tₘ, is equal to:

$${T}_{m} = \frac{{σ}_{m}}{\overline{U}} , \qquad ( 34 )$$

where the standard deviations (σₘ) in the axial, cross-current, and down directions can be calculated as:

$${σ}_{u} = \frac{{T}_{u}}{\sqrt{1 + {P}^{2} + {Q}^{2}}} , {σ}_{υ} = P {σ}_{u} , and {σ}_{w} = Q {σ}_{u} . \qquad ( 35 )$$

Here, P and Q are constants defining the ratios between the standard deviations of the flow velocities in the cross-current and down directions over the standard deviation in the axial direction.

Correlated velocity components can then be generated by a discretized one-sided PSD equation, \tilde{s}^{m}(ƒ))=G^{m} (ƒ)δƒ, where ƒ is the vector of user-selected frequencies, chosen to capture the characteristic frequencies of the flow field, ƒ [symbol] ƒ₁, ƒ₂, . . . , ƒₙ. A coherence function, Cᵢⱼ, defining the flow component's correlation between any two grid nodes on the inlet plane, can be defined by:

$${C}_{ij} ( f ) = exp ( - \frac{{R}_{c} Δ {r}_{ij} f}{\overline{U}} ) , \qquad ( 36 )$$

where Δrᵢⱼ is the distance between any two inlet plane grid nodes and R_{c} is a coherence decay constant. The amplitude of the fluctuating velocity component, S^{m}, can be written as:

$${S}_{ij}^{m} ( f ) = 2 {C}_{ij} ( f ) {{A}_{m} ( f )}^{- \frac{5}{3}} δ f . \qquad ( 37 )$$

The velocity weighting factor, H(ƒ), can then be calculated in frequency domain as:

$$\begin{matrix}{H}_{11}^{m} ( f ) = {{S}_{11}^{m} ( f )}^{\frac{1}{2}} , {H}_{21}^{m} ( f ) = \frac{{S}_{21}^{m} ( f )}{{H}_{11}^{m} ( f )} , \\ {H}_{22}^{m} ( f ) = {( {S}_{22}^{m} ( f ) - {{H}_{21}^{m} ( f )}^{2} )}^{\frac{1}{2}} , {H}_{31}^{m} ( f ) = \frac{{S}_{31}^{m} ( f )}{{H}_{11}^{m} ( f )} , \\ {H}_{ij}^{m} ( f ) = \frac{( {S}_{ij}^{m} ( f ) - {\sum }_{l = 1}^{l = j - 1} {H}_{il}^{m} ( f ) {H}_{jl}^{m} ( f ) )}{{H}_{jj}^{m} ( f )} , \\ {H}_{jj}^{m} ( f ) = {( {S}_{jj}^{m} ( f ) - {\sum }_{l = 1}^{l = j - 1} {{H}_{jl}^{m} ( f )}^{2} )}^{\frac{1}{2}} .\end{matrix} \qquad ( 38 )$$

where Hᵢⱼ^{m} is the element in the i^{th} row and the j^{th} column of H∈ [symbol] ⁿ^{_{y}}ⁿ^{_{z}}³³ⁿ^{_{y}}ⁿ^{_{z}}. The velocity weighting factor, Hᵢⱼ^{m}(ƒ), is then used to calculate analytical expressions for the velocity components, u, v, and w, as functions of time. The amplitude of the fluctuating velocity component, mₖⱼ*, can be represented as:

$${m}_{kj}^{*} = {\sum }_{l = 1}^{j} {H}_{lj}^{m} ( {f}_{k} ) {e}^{i {θ}_{kl}} , \qquad ( 39 )$$

where θₖₗ is a random phase angle between 0 and 2π. Because mₖⱼ*=|mₖₖ*∥e^{iθ}^{ₖⱼ}, where θₖⱼ is the resultant phase angle associated with each frequency component at each grid point, j,mₖⱼ* can be converted from frequency domain to time domain, where each fluctuating velocity component can be denoted as:

$${m}_{j} ( t ) = {\sum }_{k = 1}^{N} \vert {m}_{kj}^{*} \vert sin ( 2 π {f}_{k}^{*} t + {θ}_{kj} ) . \qquad ( 40 )$$

This calculation results in a grid of velocity vectors, \tilde{V}_{turb} (yₒ,zₒ, t), at each node of the inlet plane.

Control Formulation

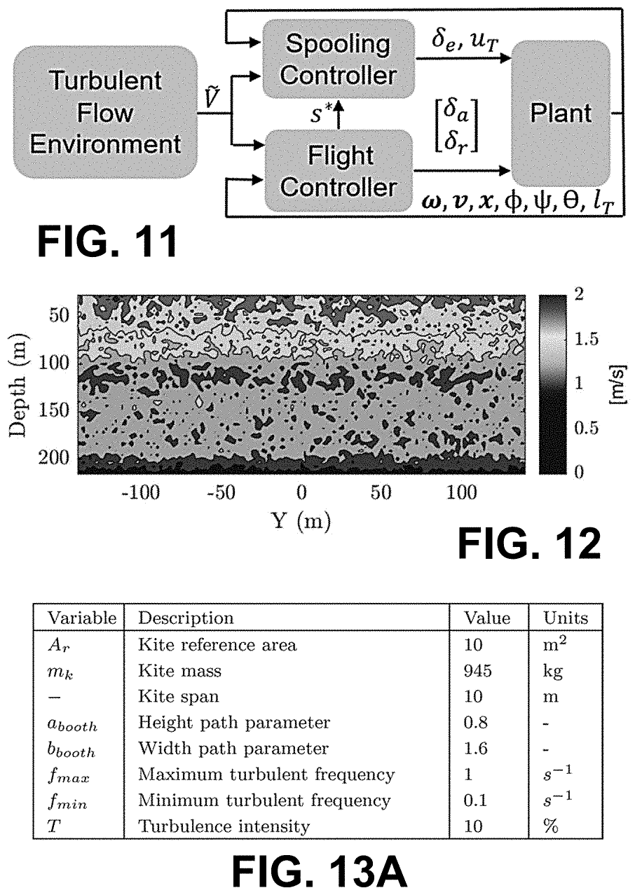

The control system can be designed to achieve two objectives: (i) Traverse a prescribed cross-current (figure-8 in this work) path that results in high tether tensions and (ii) strategically switch between high-tension spool-out and low-tension spool-in behavior in a manner that keeps the kite in a relatively consistent depth (and therefore flow) range. The former can be accomplished via a hierarchical controller, whereas the latter can be accomplished through an intra-cycle spooling controller. The complete control system block diagram (integrated with the flow model and plant) of the kite system is shown in FIG. 11.

Flight Controller. The flight controller, which enables the kite to track a prescribed figure-8 path, contains four levels. As previously described, this modular, hierarchical control structure is partitioned into a path following controller, a tangent roll angle controller, a desired moments (or movement) controller, and a control allocation module.

Control Allocation Module. In order to map the desired moment vector to the necessary control surface deflections, a linearized approximation of the nonlinear mapping from deflections to hydrodynamic moments can be inverted. This approximation can be calculated by neglecting the effect of angular velocity on the apparent flow at each fluid dynamic surface, then linearizing to obtain an expression in the form of equation (25). The variable Mₒ is given by equation (26) and the matrix A can be formed by re-arranging the cross products and deflection angles into a matrix where the results of the cross products form the columns of the matrix:

$$\begin{matrix}A = \frac{1}{2} ρ {A}_{r} {‖ {υ}_{a} ‖}^{2} [ {a}_{1} - {a}_{2} , {a}_{3} , {a}_{4} ] where \\ {a}_{i} = {r}_{{a}_{i}} \times ( {C}_{{L}_{1} , i} {u}_{L , i} + {C}_{{D}_{1} , i} {u}_{D , i} ) , i ∈ \{ 1 , 2 , 3 , 4 \} .\end{matrix} \qquad ( 41 )$$

Ultimately, this results in a system of three equations and three unknowns, which are solved in computing the control surface deflections at each time.

Winch (Spooling) Controller. The commanded rate of tether release, u_{T}(t), is set by a spooling controller that seeks to spool tether out at a high angle of attack during the portions of the lap in which large tensions are possible, then spool tether in at a low angle of attack during the remainder of the lap. The intra-cycle spooling algorithm in this work is designed to maintain a consistent tether length each lap, represented by the constraint:

∫ₜ_{_{0,j}}^{t}^{_{i,j}}ũⱼ(τ)dτ=0, (42)

where the index j refers to the lap number. This ensures that the kite remains in a consistent depth within the ocean shear profile. In attempting to find the command sequence that satisfies this constraint, several simplifying assumptions can be made:
The winch is capable of achieving the commanded speed.
The winch is capable of achieving that speed quickly, relative to the rate of change of the command.
The commanded spooling speed is piecewise constant over each of N_{R} “spooling regions”, and alternates between spooling in and spooling out at the maximum speed, uₛₚₒₒₗ.

The first two approximations should hold for a well-designed winch/generator system, meaning that ũ_{T}(t)≈u_{T}(t). The three approximations together mean that the constraint equation of (42) can be written as:

0=1^{1×N}^{_{R}}U^{j-1}Δ_{T}^{j}, (43)

where the matrix U^{j-1}∈ [symbol] ^{N}^{_{R}}^{×N}^{_{R}} is a diagonal matrix where the element in the p^{th} and q^{th} column is given by:

$${U}_{p , q}^{j - 1} = \{ \begin{matrix}{u}_{spool}^{j - 1} \\ - {u}_{spool}^{j - 1} \\ 0\end{matrix} \begin{matrix}p = q = odd \\ p = q = even \\ p \neq q .\end{matrix} \qquad ( 44 )$$

Here, uₛₚₒₒₗ^{j-1} is one third of the mean flow speed at the vehicle CM over the last lap of the system. The vector Δ_{T}^{j}∈ [symbol] ^{N}^{_{R}} is a vector containing the time durations required to traverse a specific section of the path during next (j^{th}) lap. Because the timings of the next lap are not known beforehand, it is desirable to define the tether spooling controller in terms of the path variable, s, not time. Therefore, the time-domain constraint of equation (43) is transformed to a path-domain constraint by using a numerical approximation of the time derivative of the path variable from the previous lap in each spooling region. Here, the spooling region is denoted with the index i_{R}=1, 2, . . . , N_{R}. Specifically, the i_{R}^{th} element of Δ_{T}^{j}, written as Δ_{T,i}_{_{R}}^{j} can be approximated in terms of the path variable using logged data from the previous lap, j−1. Specifically,

$${Δ}_{T , {i}_{R}}^{j} \approx \frac{{s}_{{i}_{R + 1}}^{j - 1} - {s}_{{i}_{R}}^{j - 1}}{{δ s}_{{i}_{R}}^{j - 1}} \qquad ( 45 )$$

$$= [ \begin{matrix}\frac{1}{{δ s}_{1}^{j - 1}} & 0 \\ 0 & \frac{1}{{δ s}_{1}^{j - 1}} \\ ⋮ & ⋮ \\ 0 & 0\end{matrix} \begin{matrix}⋯ \\ \\ ⋯ \\ \\ ⋱ \\ 0\end{matrix} \begin{matrix}\\ 0 \\ \\ 0 \\ \\ ⋮ \\ \frac{1}{{δ s}_{{N}_{R} + 1}^{j - 1}}\end{matrix} ] D [ \begin{matrix}{s}_{1}^{j - 1} \\ {s}_{2}^{j - 1} \\ ⋮ \\ {s}_{{N}_{R + 1}}^{j - 1}\end{matrix} ] \qquad ( 46 )$$

$${=}^{△} {δ s}^{j} {DS}^{j - 1} . \qquad ( 47 )$$

Note that sᵢ_{_{R}}^{j-1} refers to the value of the path variable at the end of the i_{R}^{th} region during the previous lap, j−1. Additionally, δsᵢ_{_{R}}^{j-1} is the mean of the derivative of s(t) over the i_{R}^{th} section of the path. Furthermore, because the path is defined using a path variable s∈{0,1}s_{N}_{_{R}}₊₁^{j}=1 for all j. The discrete difference operation matrix D∈ [symbol] ^{N}^{_{R}}^{×N}^{_{R}} is a matrix with ones along the main diagonal and negative ones on the diagonal underneath the main diagonal. Thus, after every lap, the problem of meeting the approximation of the net-zero spooling constraint becomes one of solving an approximated version of the constraint equation,

0=1^{1×N}^{_{R}}U^{j-1}δs^{j-1}DS^{j}, (48)

for the vector S^{j}∈ [symbol] ^{N}^{_{R}}⁺¹, the elements of which define the spooling regions for the next lap. Note that in general, this is a single scalar equation and cannot be solved uniquely for the elements of S^{j}. However, if a structure is prescribed to the spooling regions, the number of parameters that define the spooling regions can be reduced to one, resulting in a unique solution. In the case of the figure-8 path geometry, it is known that the tension profile over the course of a figure-8 exhibits two local minima, which occur roughly at s=0.25 and s=0.75. Therefore, the vector S^{j} takes the form:

$${S}^{j} = [ \begin{matrix}0.25 \\ 0.25 \\ 0.75 \\ 0.75 \\ 1\end{matrix} ] + [ \begin{matrix}- 1 \\ 1 \\ - 1 \\ 1 \\ 0\end{matrix} ] {s}_{w}^{j} . \qquad ( 49 )$$

By substituting this expression into equation (48), it is possible to solve directly for s_{w}^{j}, which defines the width of the spooling region for the next lap. This then defines a simple, switched spooling control structure:

$${u}_{T}^{j} ( {s}^{*} ( t ) ) = \{ \begin{matrix}{u}_{in} \\ \\ {u}_{out}\end{matrix} \begin{matrix}0.25 - {s}_{w}^{j} \leq {s}^{*} ( t ) \leq 0.25 + {s}_{w}^{j} or \\ 0.75 - {s}_{w}^{j} \leq {s}^{*} ( t ) \leq 0.75 + {s}_{w}^{j} , \\ otherwise .\end{matrix} \qquad ( 50 )$$

While equation (50) will yield zero net spooling under nominal conditions, it is not robust to disturbances that cause the actual flight speed (and therefore the time needed to traverse a particular section of the figure-8) to differ from that which was used in computing u_{T}^{j}(s*(t)). To add robustness to the spooling strategy, a simple feedback controller can be utilized to track a target tether length, l_{T,SP}^{j}(s(t)), which can be obtained by integrating equation (50) over the path as follows:

$${l}_{T , SP}^{j} ( s ( t ) ) = {l}_{T , 0} + {\int }_{0}^{s ( t )} \frac{{u}_{T}^{j} ( σ )}{{δ s}^{j - 1}} d σ . \qquad ( 51 )$$

Results

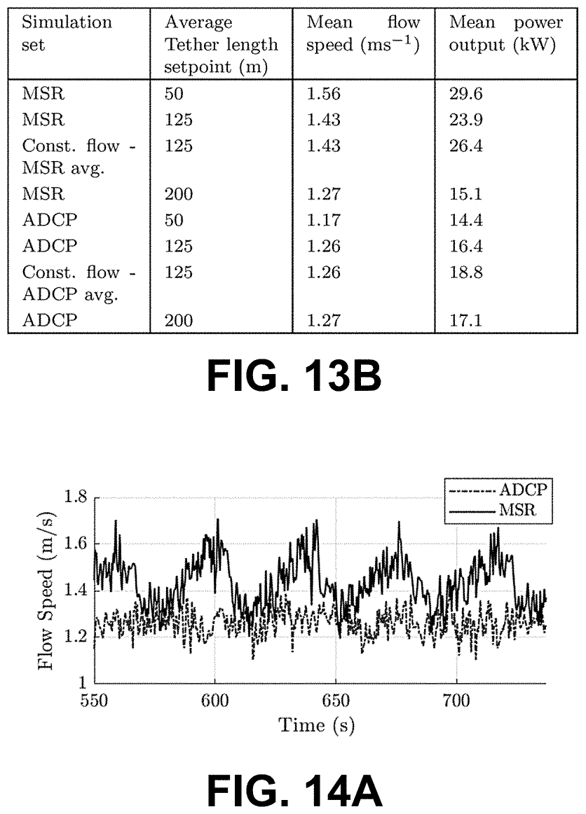

This section details two sets of simulation results, one in which the kite is deployed from a floating platform at the sea surface, and another in which the kite is deployed from the seabed. Because the ADCP data is invalid at low depths due to surface reflections, the MSR model was used to characterize the low-frequency component of flow in the former case (to be referred to as the MSR case in simulation results), whereas ADCP data was used to characterize the low-frequency component of flow in the latter case (to be referred to as the ADCP case in simulation results). In both simulation cases, an average tether length of 125 meters is used. For comparison purposes, two additional simulations were performed under spatiotemporally constant flow profiles, both at an average tether length setpoint of 125 m, where the constant flow speeds were set to the average flow speeds seen in the MSR and ADCP data. By comparing the results against constant flow simulations, it is possible to assess the effects of turbulence on the kite's power production. An example plot of the total xₒ component of flow velocity at the inlet plane (including both the low-frequency flow and high-frequency turbulence), for a single time step, is shown in FIG. 12, using ADCP data for the low-frequency component. The plot illustrates one instant in time of the xₒ component of flow velocity in the yₒ, zₒ plane for the ADCP data with superimposed turbulence. The parameters used in the simulations are shown in the table of FIG. 13A. Additionally, the average power produced in the MSR and ADCP simulation sets, along with the constant flow results, are shown in the table of FIG. 13B, as a function of average tether length setpoint and mean flow speed at the kite's center of mass.

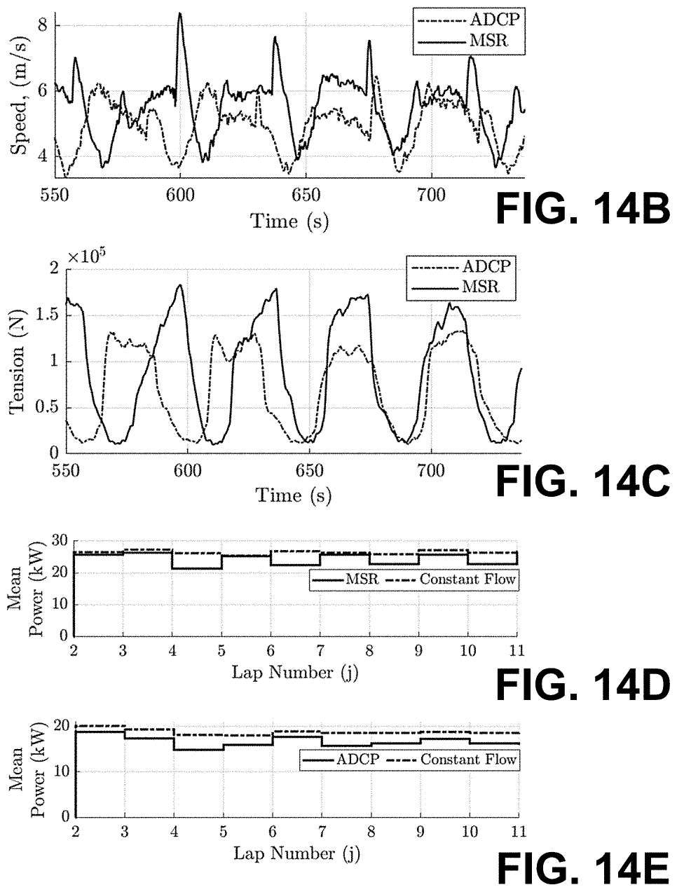

Simulation Results. A plot of the flow speed at the kite's center of mass (CM) over two laps is shown in FIG. 14A, for both the MSR and the ADCP example simulations. The periodic behavior that was observe in FIG. 14A results from the higher flow speeds experienced near the top of the path, which is a direct result of the ocean's velocity profile, an example of which can be seen in FIG. 12. The velocity of the kite over two laps can be seen in FIG. 14B for both the MSR and ADCP example simulations. Additionally, the tether tension magnitude, ∥Fₜₕᵣ∥, is shown in FIG. 14C for both the ADCP and MSR example simulations. The average power per lap is shown in FIG. 14D and FIG. 14E for the ADCP and MSR example simulations, along with the constant flow simulations (which were run at the same average flow speeds as the MSR and ADCP example simulations to provide a comparison of the kite's power production in constant flow vs. turbulent environments). The average power produced in the MSR example simulation was 23.9 kW at an average flow speed of 1.43 m/s, which is 90.5% of the average power produced in its constant flow simulation, which was 26.4 kW. In the ADCP example simulation, the average power produced was 16.4 kW at an average flow speed of 1.26 m/s, which was 87.2% of the power produced in the constant flow simulation, which was 18.8 kW. Additionally, it is clear from the simulations that the kite robustly executes cross-current flight in the presence of turbulence.

An implementation of a tethered MHK kite with closed-loop control of cross-current flight in a turbulent ocean flow environment has been presented. This was performed by generating two spatiotemporally varying ocean current profiles, using data from the MRS model for the first and observed ADCP data for the second, both with superimposed turbulence. A hierarchical flight controller and an intra-cycle spooling controller were used to control the kite. Simulations showed robust flight control in the presence of turbulence, along with power production numbers approximately 90 percent as large as in the constant flow case.

Autonomous Underwater Vehicle with Energy-Harvesting Kite

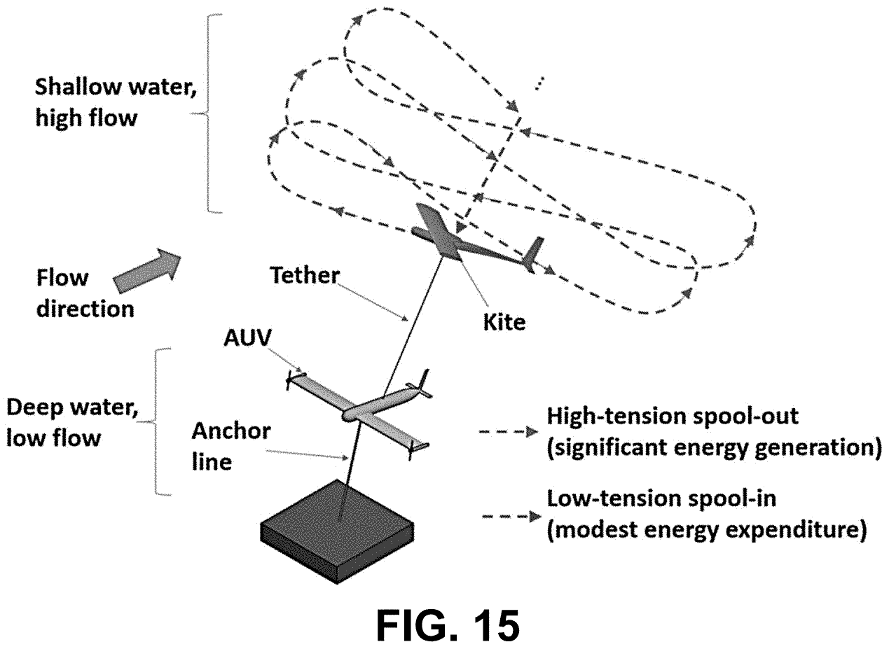

To achieve persistent operation and minimal recharging time through highly efficient energy harvesting, along with low observability through compact size, an autonomous underwater vehicle (AUV) that can deploy a small energy-harvesting kite for periodic recharging is examined. An example of the kite-based energy generation system is illustrated in FIG. 15. The kite-based energy generation system can comprise: (i) an AUV which consumes energy to move around and explore the environment, and (ii) a deployable kite system which harvests energy from the prevailing flow while the AUV is anchored close to the seabed. Thus, the AUV exhibits hybrid operation comprising two modes:
Charging, where the AUV is moored and the kite is deployed to a favorable location within the water column and executes cross-current flight in order to generate power and charge the batteries; and
Exploration, where the kite is retracted and the AUV moves through the environment.

As illustrated in FIG. 15, the AUV will deploy the kite during the charging mode. In the exploration mode, the kite is retracted, and the anchor is reeled in allowing the AUV to perform primary mission objectives.

In this section, the basic design parameters and dynamic models for the AUV and kite is presented, and a dynamic programming (DP) mission approach that is used to minimize cumulative recharging time is described. A hierarchical cross-current flight controller is introduced that is shown to yield robust power-augmenting flight over the spectrum of flow conditions experienced. Using a hind cast oceanographic resource model for the Gulf Stream adjacent to North Carolina, the efficacy of the proposed mission planning and control algorithms in realistic flow data is demonstrated. The results are compared against more naïve mission planning strategies, as well as non-cross-current energy-harvesting strategies, demonstrating that the disclosed control approach provides significantly reduced charging time.

Plant Model

The dynamic model of the AUV used here has been developed to capture features of the exploration and charging problem while suppressing various elements of the complex kite launch-land flight control problem. Modeling simplifications used to develop this optimization-oriented model include:
(1) The AUV moves at a specified velocity while moving between anchor positions.
(2) During the charging sequence, the AUV is rigidly anchored to the sea floor.
(3) The transition from the anchored, charging phase to the exploration phase (and vice versa) is handled by a lower level controller, which uses a fixed amount of time during which zero net energy is generated.

Note that this first assumption implies that the motion of the AUV follows very simple kinematics; position is merely calculated through direct integration of velocity. Furthermore, at any moment either the AUV, or the tension-based, cross flow kite (CFK) system is simulated, but the two models never operate simultaneously and there is no coupling between their dynamics.

Tension-Based, Cross Flow Kite Dynamics. The cross flow kite is modeled as a combination of two elements:
(1) A rigid lifting body wherein forces and moments can be calculated from lift, drag, buoyancy, and gravity; and
(2) A tether model comprising of a non-compressive spring-damper system subject to fluid dynamic drag, buoyancy, and gravity. One end of the tether is attached to the lifting body and exerts a force on it, and the other is attached to the AUV.

The 6 DoF lifting body (kite) model has been discussed with respect to equations (1-7). The unit vectors describing the direction of the lift and drag forces can be calculated from the apparent wind direction vector at the i^{th} aerodynamic center:

$${\vec{u}}_{D , i} = \frac{{\vec{v}}_{{a}_{i}}}{‖ {\vec{v}}_{{a}_{i}} ‖} , \qquad ( 52 )$$

$${\vec{u}}_{L , i} = \{ \begin{matrix}[ \begin{matrix}0 & 0 \\ 0 & 0 \\ 1 & 0\end{matrix} \begin{matrix}- 1 \\ 0 \\ 0\end{matrix} ] \frac{{[ {\vec{u}}_{D , i}^{x} 0 {\vec{u}}_{D , i}^{z} ]}^{T}}{‖ [ {\vec{u}}_{D , i}^{x} 0 {\vec{u}}_{D , i}^{z} ] ‖} i \neq 4 , \\ [ \begin{matrix}0 & 1 \\ - 1 & 0 \\ 0 & 0\end{matrix} \begin{matrix}0 \\ 0 \\ 0\end{matrix} ] \frac{{[ {\vec{u}}_{D , i}^{x} {\vec{u}}_{D , i}^{y} 0 ]}^{T}}{‖ [ {\vec{u}}_{D , i}^{x} {\vec{u}}_{D , i}^{y} 0 ] ‖} i = 4 ,\end{matrix} \qquad ( 53 )$$

where the components of the drag direction vector are given by the dot product with the appropriate unit vector of the kite coordinate system, [symbol] _{D,i}^{(·)}= [symbol] _{D,i}·(·)ₖ. Note that i=4 refers to the vertical stabilizer, thus requiring the case structure of equation (53).

The tether model has been discussed with respect to equations (8) and (9). Unspooled tether length, l_{T} can be calculated according to a filtered saturation-plus-integrator winch model:

$$\begin{matrix}{\overline{u}}_{T} ( t ) = min \{ max \{ {u}_{T} ( t ) , {u}_{max} \} , {u}_{min} \} \\ {\tilde{u}}_{T} ( t ) = \frac{1}{{τ}_{w}} {\int }_{0}^{t} {\overline{u}}_{T} ( τ ) - {\tilde{u}}_{T} ( τ ) d τ \\ {l}_{T} ( t ) = {\int }_{0}^{t} {\tilde{u}}_{T} ( τ ) d τ\end{matrix} \qquad ( 54 )$$

where uₘᵢₙ and uₘₐₓ are the minimum and maximum achievable tether release speeds, u_{T}(t) is the commanded tether release speed from the controller, and τ_{w} is the lumped time constant characterizing the response speed of the winch. Note that ũ_{T}(t) is the actual achieved tether release speed.

AUV Energy Storage System Model. The energy storage system of the AUV can be modeled as an on-board battery. The battery's state of charge (SoC) is saturated to lie within a lower limit, or the depth of discharge limit, and an upper limit, or maximum SoC.

The battery can be assumed to expend energy when the AUV is moving, according to a simple work-energy relationship. The battery charges when the AUV is parked, according to the appropriate expression governing the method of energy production (CFK or static flight turbine, SFT). The battery's energy level, E, is calculated according to the following equations:

$$\dot{E} ( t ) = \{ \begin{matrix}- {F}_{d} ( t ) {v}_{AUV} ( t ) , \\ {P}_{gen} ( t ) ,\end{matrix} \begin{matrix}{v}_{AUV} ( t ) \neq 0 , \\ {v}_{AUV} ( t ) = 0 ,\end{matrix} \qquad ( 55 )$$

$$E ( t ) = {\int }_{0}^{t} \{ \begin{matrix}0 , \\ \dot{E} ( τ ) d τ ,\end{matrix} \begin{matrix}{E}_{min} \leq E \leq {E}_{max} , \\ otherwise\end{matrix} \qquad ( 56 )$$

where E(t) is the energy stored in the battery, F_{d}(t) is the drag force encountered by the AUV during motion between anchor points, P_{gen}(t) is the instantaneous power generated by the system, v_{AUV} is speed of the AUV, and Eₘᵢₙ and Eₘₐₓ represent the minimum and maximum states of charge of the battery respectively.

During the exploration phase, the drag force on the AUV, F_{d}(t), is modeled as a function of the apparent flow velocity that the AUV experiences, specifically:

$${F}_{d} ( t ) = \frac{1}{2} ρ {‖ {\vec{v}}_{f} ( {\vec{x}}_{AUV} ) - {\vec{v}}_{AUV} ‖}^{2} {C}_{d} {A}_{ref}^{AUV} , \qquad ( 57 )$$

where ρ is the fluid density, [symbol] _{AUV} is the velocity vector of the AUV, and A_{ref}^{AUV} is the reference area of the turbine.

In the case of the CFK, instantaneous power produced by the system, P_{gen}(t), can be modeled as the product of an efficiency factor, η, net tether force, ∥ [symbol] ₜₕᵣ∥, and the tether release rate, ũ_{T}(t):

P_{gen}(t)=η(ũ_{T}(t))∥\vec{F}ₜₕᵣ∥ũ_{T}(t) (58)

where the efficiency factor, η, differs depending on whether the system is spooling in, thus operating as a winch, or spooling out, thus operating as a generator:

$$η ( \tilde{u} ( t ) ) = \{ \begin{matrix}{η}_{gen} , \\ \frac{1}{{η}_{winch}}\end{matrix} , \begin{matrix}\tilde{u} ( t ) \geq 0 \\ \tilde{u} ( t ) < 0.\end{matrix} \qquad ( 59 )$$

In the case of the SFT energy generation system, the generated power is calculated as:

$${P}_{gen} ( t ) = {η}_{turb} \frac{{N}_{turb}}{2} ρ {‖ {\vec{v}}_{f} ( {\vec{x}}_{Turb} ) ‖}^{3} {A}_{ref}^{turb} , \qquad ( 60 )$$

where η_{turb} is the turbine efficiency, [symbol] _{Turb} is the position of the turbine(s), N_{turb} is the number of turbines, and A_{ref}^{turb} is the reference area of a single turbine. Here, assume that the turbine is operating below its rated flow speed.

Control Details

The proposed control strategy seeks to achieve rapid exploration of the environment while maintaining the SoC of the on-board battery via efficient kite flight. This ultimately can be achieved by (i) strategically selecting recharging locations to lie in areas of favorable flow and (ii) operating the kite robustly and efficiently when it is deployed. The first goal is achieved by a high-level mission planning controller that uses a DP optimization over a fixed spatial horizon to minimize charging time while satisfying terminal SoC constraints. A lower-level hierarchical flight controller is then used when the kite is deployed to achieve robust, efficient energy-harvesting motions.

High Level Controller: Dynamic Programming Based Solution. The high level controller seeks to solve an optimization problem that captures the need to explore the space rapidly while meeting SoC constraints. This is formulated in the following constrained optimization problem, which is applied over a fixed spatial horizon, given an estimate of the flow resource:

$${minimize}_{u} J ( u ; E ( 0 ) ) = {\sum }_{i = 0}^{N - 1} u ( i ) + K ( u ( i ) ) , \\ \begin{matrix}subject to : E ( i + 1 ) = E ( i ) - {E}_{loss} ( i ) + u ( i ) {P}_{gen} ( i ) \\ {E}_{min} \leq E ( i ) \leq {E}_{max} ∀ i \\ E ( N ) \geq E ( 0 ) \\ u ( i ) \geq 0 ∀ i\end{matrix} \qquad ( 61 )$$

where i represents a discretized spatial location, u(i) is the time spent charging at each spatial location, and u=[u(0) . . . u(N−1)]^{T} is the sequence of charging decisions. The function K(u(i)) specifies the time required to deploy the kite (K(u(i))=0 if u(i)=0 and is K(u(i))=K₀ otherwise), and Eₗₒₛₛ(i) is the energy expended in moving from spatial location i to i+1. The variables E(i) and P_{gen}(i), as defined earlier, represent the battery SoC and power generated by the kite, respectively.

The first constraint simply characterizes the recharging dynamics, whereas the second constraint imposes saturation limits on the battery SoC. The third constraint requires that the AUV finish the exploration with at least the stored energy it started with, thereby ensuring that the AUV can achieve persistent missions. Given the significant distance between subsequent spatial locations (1.06 km, or 1 percent of the mission transect in this work), and the consequent substantial available time for computation, DP was used to compute the optimal solution to the aforementioned mission planning problem.

High Level Controller: Baseline Control Strategy. The baseline control strategy used for comparison in this work is implemented as a naive, myopic charging strategy. That is, the system explores until the battery is fully depleted, or does not have enough charge to travel to the next location, and then charges back to the maximum SoC.

Low Level Cross Flow Kite Flight Controller. The flight control strategy is ultimately responsible for (i) ensuring that the kite robustly tracks a prescribed figure-8 cross-current flight path, while (ii) spooling in and out in a strategic way that ensures high tension on spool-out and low tension on spool-in.

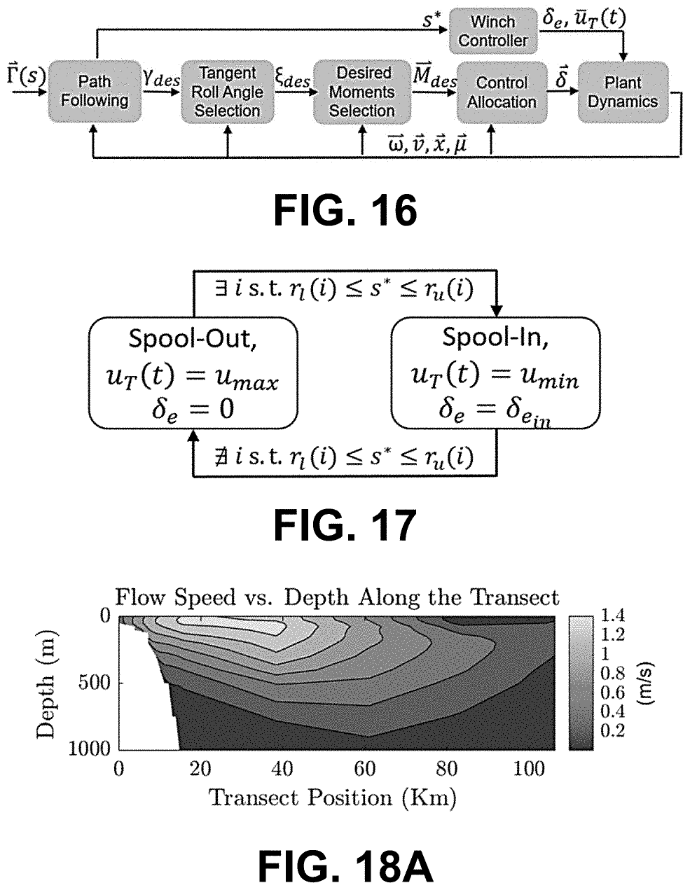

The figure-8 tracking control strategy contains four levels, each of which can accept feedback from the plant in calculating their outputs. FIG. 16 illustrates an example of the four stage hierarchical controller, where [symbol] =[δₐ, δₙ]. As previously described, this modular, hierarchical control structure is partitioned into:
(1) A path following controller that accepts the path geometry and outputs a desired velocity angle;
(2) A tangent roll angle controller, which accepts a desired velocity angle and outputs a desired tangent roll angle, which is the angle between [symbol] ₖ and the plane tangent to the surface of the sphere of radius ∥ [symbol] ∥ at the kite's position—this angle dictates the component of hydrodynamic lift that contributes to turning in order to follow the path;
(3) A desired moment controller, which accepts the tangent roll setpoint and side slip angle setpoint, and outputs a desired moment vector; and
(4) A control allocation module, which accepts the desired moment vector and computes the required control surface deflections to be actuated by the ailerons, elevators, and rudder of the kite.

The spooling mechanics are managed by a winch controller, shown in FIG. 17 illustrates an example of a winch controller state machine where rₗ∈ [symbol] ⁿ, rᵤ∈ [symbol] ⁿ are the sets of upper and lower limits on path variable, s, that define the spool-in regions of the path This controller employs a state machine to calculate the spooling speed and elevator deflection, the latter of which modulates the angle of attack to generate high tension during spool-out and low tension during spool-in.

Control Allocation Module: To map the desired moment vector to the necessary control surface deflections, an approximation of the deflection-moment mapping used in the plant model can be inverted. This approximation can be calculated by neglecting the effect of angular velocity on the apparent flow at each fluid dynamic surface. Under this approximation, equations (4) and (6) can be rearranged to the form:

$${\vec{M}}_{net} = {\vec{M}}_{o} + [ A ] [ \begin{matrix}{δ}_{a} \\ {δ}_{e} \\ {δ}_{r}\end{matrix} ] + [ B ] [ \begin{matrix}{δ}_{a}^{2} \\ {δ}_{e}^{2} \\ {δ}_{r}^{2}\end{matrix} ] \qquad ( 62 )$$

where δₐ is the deflection angle of the ailerons, δₑ is the deflection angle of the elevators, and oᵣ is the deflection angle of the rudder. In this expression, the variable [symbol] is given by:

$${\begin{matrix}{\vec{M}}_{o} = \frac{1}{2} {ρ A}_{r} {‖ {\vec{v}}_{a} ‖}^{2} {\sum }_{i = 1}^{4} {\vec{r}}_{{a}_{i}} \times ( {C}_{{L}_{o} , i} {\vec{u}}_{L , i} + {C}_{{D}_{o} , i} {\vec{u}}_{D , i} ) & ( 63 )\end{matrix}}_{}$$

and the matrix [A] is formed by re-arranging the cross products and deflection angles in equations (4) and (6) into a matrix form where the results of the cross products form the columns of the matrix,

$$\begin{matrix}[ A ] = \frac{1}{2} {ρ A}_{r} {‖ {\vec{v}}_{a} ‖}^{2} [ {\vec{a}}_{5} , {\vec{a}}_{2} , {\vec{a}}_{3} ] where \\ {\vec{a}}_{i} = \{ \begin{matrix}{\vec{r}}_{{a}_{i}} \times ( {C}_{{L}_{1} , i} {\vec{u}}_{L , i} + {C}_{{D}_{1} , i} {\vec{u}}_{D , i} ) \\ {\vec{a}}_{1} - {\vec{a}}_{2}\end{matrix} \begin{matrix}i ∈ \{ 1 , 2 , 3 , 4 \} \\ i = 5.\end{matrix}\end{matrix} \qquad ( 64 )$$

The elements of [B] can be calculated analogously using the second order coefficients of equation (6).

Finally, to invert equation (62), it can be assumed that the elements of [B] are negligible in comparison to the elements of [A]. This assumption can be justified by the realization that, for a well designed kite, operating outside the stall region, the moment-deflection relationship should be odd, not even, i.e., deflecting the control surface in the opposite direction should change the sign of the moment generated. Thus, the deflection-moment mapping will be dominated by the linear terms in [A]. Under the simplification [B]=0, equation (62) can be solved directly using the inverse, or to ensure invertibility, the left pseudo-inverse. The individual control surface deflections can then be calculated according to δ₁=−δ₂=δₐ, δ₃=δₑ, and δ₃=δᵣ.

Results

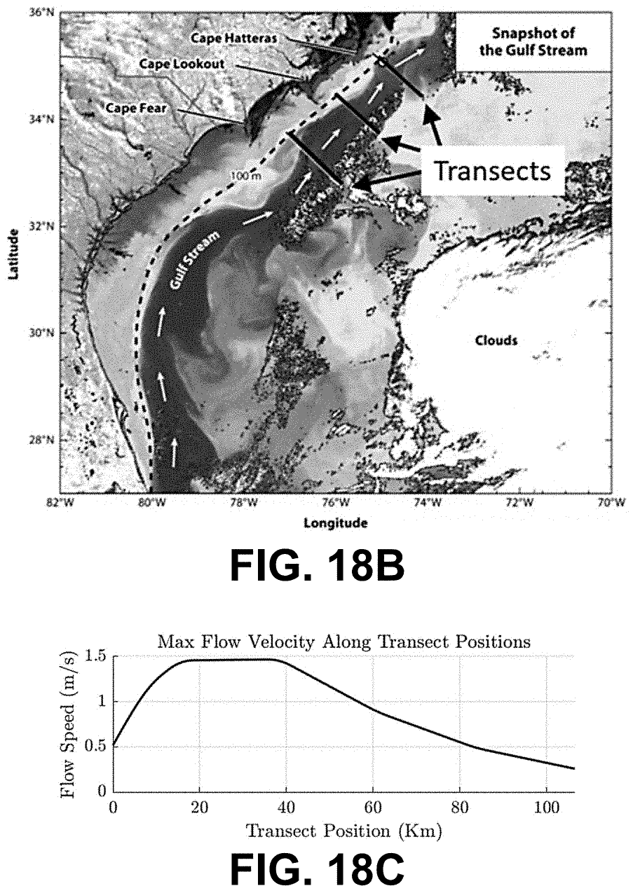

The combined high-level mission planning algorithm and low-level kite control algorithm were simulated based on an oceanographic hind cast model. This realistic spatiotemporal data represents a two-dimensional planar slice (transect) of the Gulf Stream off the coast of North Carolina, shown in FIG. 18A. The flow speed as a function of transect position and depth. This data was collected on Oct. 19, 2015 at 15:00:00. FIG. 18B illustrates an example of a sea surface temperature map of the Gulf Stream in the southern Atlantic Ocean, in March 2018. The topmost transect in the figure was used. FIG. 18B shows sample data across the transect, where the maximum magnitude of the flow speed within the water column, as a position of longitudinal position along the transect, is shown in FIG. 18C. The figure depicts the maximum flow speed in the water column at each transect discretization. This data was collected on Oct. 19, 2015 at 15:00:00.

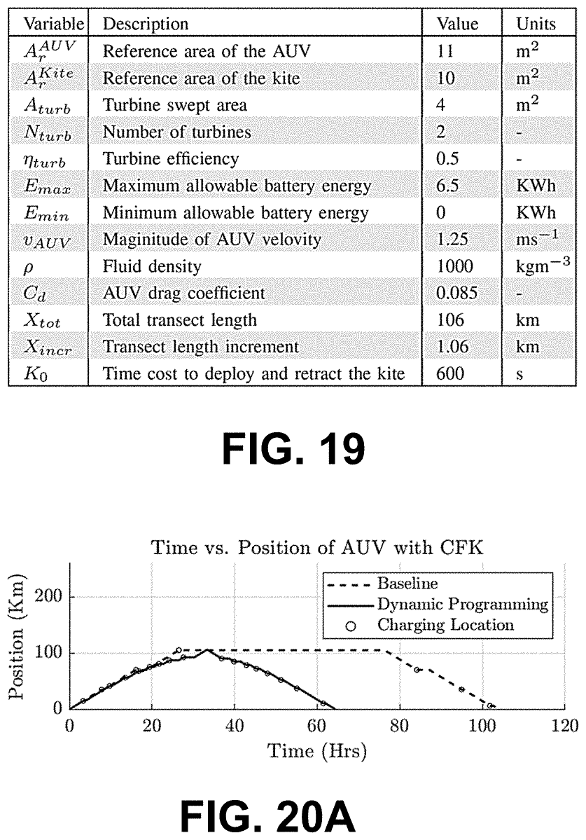

For the simulations studied here, the mission was defined as a complete traversal of the transect, returning to the starting position. Because of the terminal SoC constraints that were imposed within the charging framework, it is ensured that this mission can be repeated persistently. The simulation results examine the following combinations of charging controllers and energy generation methods:
1) Baseline charging controller with a CFK,
2) DP charging controller with a CFK,
3) Baseline charging controller with an SFT, and
4) DP charging controller with an SFT. The parameters used in the four simulations are shown in the table of FIG. 19.

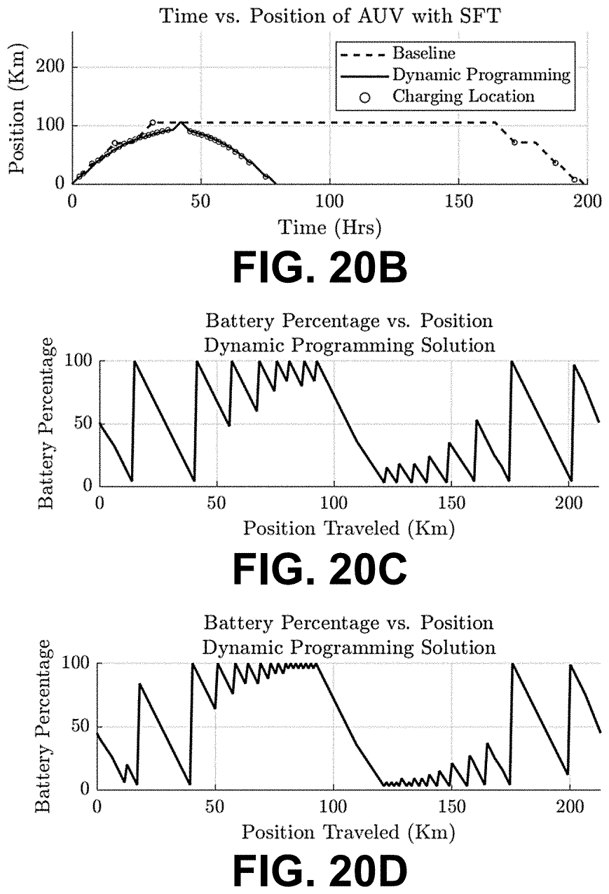

Simulation Results. The time taken to cross and return across the transect is shown in FIGS. 20A and 20B for both methods of energy generation. FIG. 20A illustrates time versus position for both the dynamic programming solution and the baseline solution for an AUV with a CFK and FIG. 20B illustrates time vs. position for both the dynamic programming solution and the baseline solution for an AUV with a SFT energy generation method. The DP solution charging strategy allowed the AUV to cross and return in 64.4 hours and 79.0 hours for the CFK and SFT methods respectively, while the baseline charging strategy took 104 hours and 198 hours for the CFK and SFT methods respectively performing the same task. It is clear from these figures the best simulated solution for an AUV repeatedly crossing the Gulf Stream uses a CFK energy generation method and a charging strategy prescribed by the DP solution. FIGS. 20C and 20D show the charging strategy for the AUV using the CFK and SFT method of energy generation respectively from the dynamic programming optimization. FIG. 20C illustrates percentage of total battery energy for the dynamic programming solution for an AUV with a CFK and FIG. 20D illustrates percentage of total battery energy for the dynamic programming solution for an AUV with a SFT energy generation method.

The optimal charging strategy and method of energy harvesting was investigated for a perpetual endurance AUV. A dynamical programing based and naïve control strategy as applied to both a cross flow kite and static flight turbine was simulated. In both instances the DP solution outperformed the baseline charging strategy. Furthermore, the crosswind kite enabled faster transect crossings by reducing charging time.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for kite-based energy generation, comprising:
deploying a kite in a flow of fluid, the kite coupled to a winch through a tether;
controlling movement of the kite along a continuous pattern across the flow of fluid, wherein the kite applies tension greater than a threshold value to the tether during at least a first portion of the continuous pattern and applies tension less than the threshold value to the tether during at least a second portion of the continuous pattern; and
generating power by a generator of the winch during the first portion of the continuous pattern.

2. The method of claim 1, wherein the winch spools out the tether during the first portion of the continuous pattern.

3. The method of claim 2, wherein the kite moves with a high angle of attack during the first portion of the continuous pattern.

4. The method of claim 2, wherein the winch spools in the tether during the second portion of the continuous pattern.

5. The method of claim 4, wherein the kite moves with a low angle of attack during the second portion of the continuous pattern or glides radially towards the winch during the second portion of the continuous pattern.

6. The method of claim 2, wherein the winch spools out the tether over multiple cycles of the continuous pattern.

7. The method of claim 1, wherein the kite further applies tension greater than the threshold value to the tether during a third portion of the continuous pattern and applies tension less than the threshold value to the tether during a fourth portion of the continuous pattern.

8. The method of claim 7, comprising generating power by the generator of the winch during the third portion of the continuous pattern

9. The method of claim 1, wherein the continuous pattern is a figure-8 or elliptical pattern.

10. The method of claim 9, wherein the continuous pattern is substantially perpendicular to a predominant flow of the fluid.

11. The method of claim 1, wherein the fluid is water and the continuous pattern is a cross-current pattern.

12. The method of claim 1, wherein the fluid is air and the continuous pattern is a crosswind pattern.

13. The method of claim 1, wherein the kite is deployed from a vehicle.

14. The method of claim 13, wherein the vehicle is an autonomous vehicle tethered to a surface.

15. A kite-based energy generation system, comprising:
a kite configured for deployment in a fluid flow, the kite comprising control surfaces that control movement of the kite along a continuous pattern across the flow of fluid;
a winch connected to the kite by a tether, where the kite applies tension greater than a threshold value to the tether during at least a first portion of the continuous pattern and applies tension less than the threshold value to the tether during at least a second portion of the continuous pattern, and a generator of the winch generates power during the first portion of the continuous pattern; and
a spool controller configured to control spooling of the tether during at least the first and second portions of the continuous pattern.

16. The kite-based energy generation system of claim 15, wherein the winch spools out the tether during the first portion of the continuous pattern.

17. The kite-based energy generation system of claim 15, wherein the kite further applies tension greater than the threshold value to the tether during a third portion of the continuous pattern and applies tension less than the threshold value to the tether during a fourth portion of the continuous pattern.

18. The kite-based energy generation system of claim 15, wherein the continuous pattern is a cross-current pattern in a liquid or a crosswind pattern in a gas.

19. The kite-based energy generation system of claim 15, comprising an autonomous underwater vehicle (AUV) configured to deploy the kite.

20. The kite-based energy generation system of claim 19, wherein the AUV is tethered to a surface.
